(19) United States
(12) Patent Application Publication
(10) Pub. No.: US 2005/0207389 A1
(43) Pub. Date: Sep. 22, 2005

(54) System and method for multiplexed frequency and time data transmission

(75) Inventors: Stephen S. Shiao, Coral Springs, FL (US); Patrick J. Doran, Fairfax, VA (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/806,001

(22) Filed: Mar. 22, 2004

(51) Int. Cl. H04B 7/212

(52) U.S. Cl. 370/348; 370/337

(57) ABSTRACT

Wireless communications devices (102, 104, 106) that communicate via an adaptive bandwidth communications protocol (300). Wireless devices (102, 104, 106) utilize a multiple carrier time division/frequency division multiplexing format where time slots (330, 332) are adaptively assigned across multiple RF carriers. Preferred embodiments assign time coincident time slots (330, 340, 350, 360) on multiple RF carriers so as to allow shorter transmission and reception times and therefore shorter transmitter and receiver activation times in order to conserve power in portable devices (104, 106). Time slots are adaptively assigned and deallocated in response to events that alter communications bandwidth requirements.

### FIELD OF THE INVENTION

The present invention generally relates to the field of wireless data communication systems and more particularly to transmission and reception of modulated data carriers.

### BACKGROUND OF THE INVENTION

Wireless communications systems are evolving to transmit data to and among multiple wireless devices within higher average data bandwidths of transmission to each wireless device. Greater average transmission bandwidths are desired in order to support a larger number of users for received data. A number of wireless devices are able to be in simultaneous communications with a single base station and each wireless device is able to have different average data rate needs. Some device might require a high average bandwidth data link while others are able to operate effectively with lower average data rates. A single wireless device is also able to have variable average data rate needs, such as a wireless device that initially receives voice data and then changes to receiving video data. Wireless communications networks can vary the average data rate used to communicate with a particular wireless device.

Introducing higher average data bandwidth transmission protocols often require an increase in processing power at the receiver and thereby increases the power consumption of the receiver and/or transmitter. This is in conflict with a general desire to minimize wireless receiver and transmitter power consumption, particularly with portable wireless devices that operate with battery power.

Therefore a need exists to overcome the problems with the prior art as discussed above.

### SUMMARY OF THE INVENTION

According to an embodiment of the present invention, a method for receiving digital data includes receiving a plurality of RF carriers where at least two carriers of the plurality of carriers are divided into a periodic series of timeslots for each carrier. Each timeslot in the periodic series of timeslots is able to carry independent data content and the at least two carriers are each modulated with different portions of a single data stream during at least one timeslot of each carrier within the periodic series of timeslots. The method further includes demodulating the at least two carriers to detect the different portions of the single data stream and assembling the different portions of the single data stream to reconstruct the single data stream.

In a further aspect of the present invention, a wireless device has a receiver that receives a plurality of RF carriers. The at least two carriers of the plurality of carriers are divided into a periodic series of timeslots for each carrier. Each timeslot in the periodic series of timeslots is able to carry independent data content and the at least two carriers are each modulated with different portions of a single data stream during at least one timeslot of each carrier within the periodic series of timeslots. The wireless device further has a demodulator that demodulates the at least two carriers to detect the different portions of the single data stream and a demultiplexer that assembles the different portions of the single data stream to reconstruct the single data stream.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an exemplary communications network that incorporates embodiments of the present invention.

FIG. 2 illustrates a time/frequency relationship for four RF channels as are used in an exemplary embodiment of the present invention.

FIG. 3 illustrates a time to time/frequency division multiplexing diagram as is performed by an exemplary embodiment of the present invention.

FIG. 4 illustrates a block diagram for a wireless device for a wireless device according to an exemplary embodiment of the present invention.

FIG. 5 illustrates a processing block diagram for DSP module.

FIG. 6 illustrates a slot assignment processing flow diagram as is performed by an exemplary embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

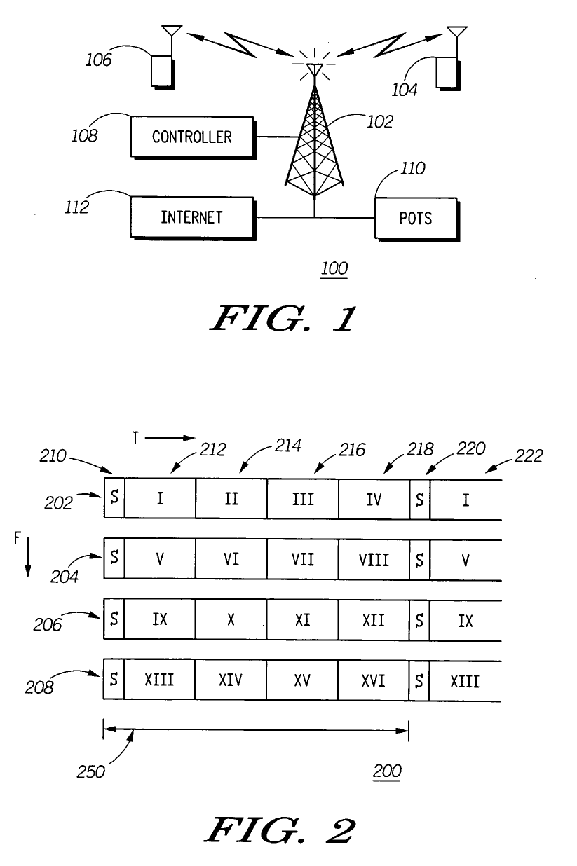

FIG. 1 illustrates an exemplary communications network 100 that incorporates embodiments of the present invention. The exemplary communications network 100 incorporates wireless devices, such as wireless handset A 104 and wireless handset B 106. The exemplary communications network 100 also includes a base station 102 that is in simultaneous, bidirectional wireless communications with remote wireless devices, such as wireless handset A 104 and wireless handset B 106. The operation of the wireless network in the exemplary embodiment is controlled by a controller 108. The exemplary communications network 100 supports communications between or among wireless handsets and between one or more wireless handsets and landline connected destinations. Examples of landline connected destinations include Plain Old Telephone System (POTS) 110 and data sources connected through the Internet 112.

The base station 102 and the wireless devices are able to establish wireless communications at variable average data rates. Base station 102 of this exemplary embodiment transmits a number of RF carriers that are each time divided into a number of timeslots. Each RF carrier transmitted by base station 102 in this exemplary embodiment is a time division multiplexed (TDM) carrier. Wireless devices receiving transmissions from the base station 102 process control information transmitted in service timeslots as well as user data contained in timeslots assigned to that wireless device, as is described below.

The wireless devices, such as wireless handset A 104 and wireless handset B 106, transmit during at least one timeslot on at least one specified RF frequency that are assigned to that wireless device by the controller 108. The wireless devices transmit in a time division, multiple access (TDMA) format on one or more frequencies, as is described below. Wireless deices are able to be assigned a variable number of timeslots on one or more RF channels on which to transmit and/or receive according to the current data communications bandwidth requirements for the wireless device. The exemplary embodiment described herein is based upon the WiDEN Wide Band iDEN radio system produced by Motorola, Inc. of Schaumburg, Ill.

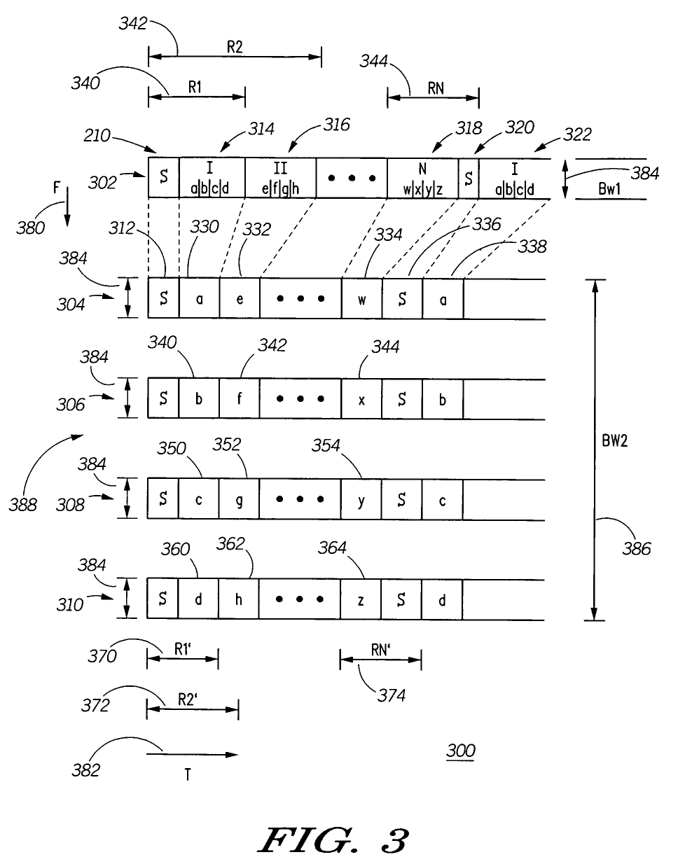

FIG. 2 illustrates a time/frequency relationship 200 for four RF channels as are used in an exemplary embodiment of the present invention. The time frequency relationship 200 illustrates the time division of four RF channels, channel A 202, channel B 204, channel C 206 and channel D 208. Each RF channel includes a service timeslot 210 in which communications service maintenance data is transmitted. The time/frequency relationship 200 illustrates a time division frame period 250, which is a period of time over which RF channels are divided into time division channels. The time division for the RF channels repeats each time division period 250 and data transmitted in a particular timeslot in each time division frame is able to be combined to from a continuous data stream.

The exemplary embodiment of the present invention uses one set of RF channels to transmit from base station 102 to wireless devices, such as wireless handset A 104, and another set of RF channels to transmit from wireless devices to base station 102. Both of these RF channel sets are divided into time division frames. Transmissions from the base station 102 are referred to herein as downlink signals, and transmissions from wireless devices are referred to herein as uplink signals. The uplink and downlink signals in the exemplary embodiment use the same time division frame period 250, although that is not a requirement. The time division frame periods 250 for uplink signals are also not required to coincidently occur in time with the time division frame periods 250 for the downlink signals, although a fixed relationship is advantageous and is used by the exemplary embodiment.

The exemplary time frame period 250 beings with a service timeslot 210. Base station 102 transmits a time synchronization transmission, channel/timeslot assignments for remote wireless devices and other maintenance data during the service timeslot 210. Remote wireless devices in some embodiments transmit uplink transmission bandwidth requests or other requests during the service timeslot 210. The base station 102 in the exemplary embodiment transmits a specially formatted data transmission that is readily identified by receiving wireless devices. All remote wireless communications devices in the exemplary embodiment receive and process the data transmitted in the service timeslot 210 in order to maintain timeslot synchronization with the time division frame period 250 and receive channel assignment and other maintenance data.

The time division frame period 250 has four user timeslots following the service timeslot 210. User timeslots are used to communicate user data, such as voice conversations and video information, and have a duration of fifteen (15) milliseconds in the exemplary embodiment. A first user timeslot 212, a second user timeslot 214, a third user timeslot 216 and a fourth user timeslot 218 are defined within this plurality of user timeslots. Each RF channel is conceptually divided according to these user timeslots and the time division frame period 250. As is illustrated, RF channel A 202 is divided into timeslots I through IV, RF channel B 204 is divided into timeslots V through VIII, RF channel C 206 is divided into user timeslots IX through XII, and RF channel D 208 is divided into user timeslots XIII through XVI. Controller 108 is able to assign one or more user timeslots, which are able to be on either one or multiple RF channels, for use by a particular remote wireless device. As an example, user timeslots I is typically assigned to a particular wireless device for communications and data to or from that device in transmitted in each slot I of each frame while that slot is assigned to that wireless device.

A single data stream, such as a voice conversation or video stream, is able to be transmitted by dividing it across multiple timeslots that are either on the same RF channel or distributed across multiple RF channels. Each timeslot allows a fixed number of user data bits to be transmitter during the duration of the time division frame period 250. Controller 108 is able to vary the average data rate available to a wireless device by assigning a different number of timeslots, on one or more RF channels, within the time division frame period 250 to a particular wireless device. Exemplary embodiments of the present invention support dynamically changing the timeslot assignments to each wireless device for each time division frame period 250 since timeslots are assigned in the service timeslot 210.

After a particular instance of time division frame period 250, the time division of the RF channels repeats. The time division frame repeats periodically with a period equal to the time duration of the timeslot frame period 250. Operation of embodiments of the present invention is facilitate if the time duration of the time division frame remains constant, but some embodiments operate with timeslot frame periods 250 that are able to have durations that change from frame to frame. The time/frequency relationship 200 shows that the fourth user timeslot 218 is followed by a second service timeslot 220, which is another iteration of the service timeslot 210. The second service timeslot is followed by a second first user timeslot 222, which is another iteration of the first user timeslot 212 and contains data following that in the first user timeslot 212.

FIG. 3 illustrates a time to time/frequency division multiplexing diagram 300 as is performed by an exemplary embodiment of the present invention. The time to time/frequency division multiplexing diagram 300 illustrates the reallocation of data from a single TDM RF channel 302 to multiple TDM RF channels 388. A single RF channel 302 is shown to include a service timeslot 210 followed by user timeslot I 314, user timeslot II 316 and user timeslot N 318. That time division frame is then repeated with a second service timeslot 320 and a second timeslot I 322. The single RF channel 302 is shown to have a bandwidth of BW1 384.

The multiple TDM RF channels 388 of this exemplary embodiment include four (4) RF channels that extend over an RF bandwidth BW2 386. RF bandwidth BW2 386 in this example is equal to four times the bandwidth of BW1 304. This is because four RF channels with the same channel symbol rate as the single TDM RF channel 302 are carried in this bandwidth.

Each of the four RF channels in the plurality of RF channels 388, i.e., RF channel A 304, RF channel B 306, RF channel C 308, and RF channel D 310, is similar to the single TDM RF channel 302, and in fact each of these plurality of RF channels have a format similar to and is able to be configured a another single TDM RF channel 302. The exemplary embodiment of the present invention configures these four RF channels so as to subdivide and distribute data that is contained within one user timeslot of the single TDM RF channel 302 across the four RF channels of the plurality of RF channels 388. For example, data contained within user timeslot I 314 of the single TDM RF channel 302 is shown as subdivided into four subparts: subpart a, subpart b, subpart c, and subpart d. The data contained in user slot 11 316 of the single TDM RF channel 302 is similarly subdivided into four subparts: subpart e, subpart f, subpart g, and subpart h. The user timeslot N 318 is also subdivided into four subparts: subpart w, subpart x, subpart y and subpart z. These subparts are then distributed across the four RF channels of the plurality of RF channels 388.

Each of the subdivided portions of each of the user timeslots of the single TDM RF channel 302 is divided across the four RF channels of the plurality of RF Channels 388. For example, subpart a is placed into the first user timeslot of RF channel A 330, subpart b is placed into the first user timeslot of RF channel B 340, subpart c is placed into the first user timeslot of RF channel C 340, and subpart d is placed into the first user timeslot of RF channel D 340. This results in using only our fourth of the time to transmit the data that would be transmitted in the first user timeslot 314 of the single TDM RF channel 302. This advantageously allows the receiver or transmitter of this data to operate for only this shorter time period.

It is to be further noted that the data in the second user timeslot 316 of the single TDM RF channel 302 is similarly subdivided and distributed across the four RF channels of the plurality of RF channels 388. In particular, subpart e is placed into the second user timeslot of RF channel A 332, subpart e is placed into the second user timeslot of RF channel B 342, subpart f is placed into the second user timeslot of RF channel C 352, and subpart g is placed into the second user timeslot of RF channel D 362. Further, the data allocated to user timeslot N 318 of the single TDM RF channel 302 is also subdivided and distributed to the four RF channels of the plurality of RF channels 388. In particular, subpart w is placed into the Nth user timeslot of RF channel A 334, subpart x is placed into the Nth user timeslot of RF channel B 342, subpart y is placed into the Nth user timeslot of RF channel C 352, and subpart z is placed into the Nth user timeslot of RF channel D 362. A second service timeslot 326 follows the Nth slot of each RF channel within the plurality of RF channels 388. The time division frame for the plurality of RF Channels 388 then repeats, as is indicated by the second first timeslot of RF channel A 338.

The exemplary embodiment uses a multiple channel time division frame period that is shorter than those used for the single TDM RF channel 302. Alternative embodiments use time division frames that are as long as those used for the single TDM RF channel 302.

Wireless devices, particularly portable wireless devices, minimize energy consumption by power and operating portions of their circuitry only when needed. An example of this type of power conservation is operating transmit and receive circuits only when they are required. The time to time/frequency division multiplexing diagram 300 illustrates the receiver operating time for the example of signal reception by a wireless device communicating through user timeslots assigned in both the single TDM RF channel 302 as well as to user timeslots in the plurality of RF channels 388. An example is shown where a first receiver R1, such as wireless handset A 104, is assigned to receive in the first user timeslot 314 of the single TDM RF channel 302. The transmit processing for this device in this scenario is similar. It is understood in this example that receiver R1 is assigned to also receive data on the first user timeslot of subsequent time division frames of the single TDM RF channel 302, as discussed above with reference to FIG. 2. Receiver R1 is also shown in this example to receive for time period R1 340. Time period R1 340 includes the multiple channel service timeslot 312 and the first user timeslot 314. This allows the wireless device to receive service timeslot transmissions as well as user data destined for that wireless device.

A second wireless device R2 is shown in this example as being assigned to receive data on the second user timeslot 316 of the single TDM RF channel 302. Second receiver R2 is shown to receive data for period R2 342, which includes the multiple channel service timeslot 312, the first user timeslot 314 and the second user timeslot 316. Although the second receiver R2 does not process the data received in the first user timeslot 314, the processing of this receiver is simplified by only discontinuing operation of the receive circuits during one period per time division frame, i.e., during user timeslots following the second user timeslot 316. Further embodiments do ids able receiver processing during the first user timeslot 314.

This example further shows an Nth receiver to be assigned to the Nth user timeslot 318 of the single TDM RF channel 302. The Nth user timeslot in this example is the last user timeslot defined for the time division frame of the single TDM RF channel 302. The Nth receiver is shown to be operated during time period RN 344, which includes the Nth user timeslot 318 and the second service timeslot 320, which is the service timeslot for the time division frame that is after the time division frame that contains the Nth user timeslot 318. Configuring receiver RN to receive the service timeslot in the next time division frame advantageously allows the receiver circuits of receiver RN to be energized and operated for a shorter period of time.

An example of an alternative operating scheme is also shown in the time to time frequency division multiplexing diagram 300 where the wireless devices are, instead, assigned user timeslots within each of the plurality of RF channels 388. Receiver R1 in this alternative operating scheme is shown as operating its receiver circuits during period R1′ 370 in order to receive the multiple channel service timeslot 312 and the first user slot for each of the four RF channels within the plurality of RF channels 388. In this case, receiver R1 receives the first user slot of RF channel A 330, the user slot of RF channel B 340, the first user slot of RF channel C 350, and the first user slot of RF channel D 360. Wireless devices used in the exemplary embodiment are able to simultaneously transmit and process these four RF channels. These wireless devices are also able to simultaneously generate and transmit four $ channels as an uplink signal.

As discussed above, the user timeslots for the plurality of RF channels 388 are essentially one fourth the period of the user timeslots of the single TDM RF channel 302. Wireless device R1 is therefore able to energize and operate its receiver circuits only during period R1′ 370, which is somewhat shorter than time period R1 340. Time period R1 340 includes multiple service timeslot 312 and the first user timeslot 314. First user timeslot 314 is approximately four times longer than, for example, the first user timeslot of RF channels A 330. This shortens the receiver operation time by approximately three fourths of the user timeslot period for the single TDM RF channel 302. In operation, however, circuit turn-on and stabilization time, as well as time synchronization uncertainties, cause the receiver circuits operation period to be greater than just the time period of the assigned timeslots being received.

Receiver R2 is shown to similarly operate for time period R2′ 372 when assigned user timeslots that are distributed across the plurality of RF channels 388. Time period R2′ 372 is shorter than time period R2 342 for reasons that are similar to those discussed with respect to time period R1′ 370. Receiver RN similarly operates for the shorter time period RN′ 374.

The exemplary embodiment uses four RF channels. Further embodiments use fewer or more RF channels that are contained within a plurality of RF channels 388.

FIG. 4 illustrates a block diagram for a wireless device 400 for a wireless device according to an exemplary embodiment of the present invention. This exemplary wireless device is a cellular telephone that communicates by transmitting and receiving digitally modulated time division and time/frequency division RF signals. Wireless device 400 includes an antenna 402 that is connected to a receiver 404 and transmitter 406. Receiver 404 is an RF to baseband receiver as are known to ordinary practitioners in the relevant arts. The baseband analog output 405 of receiver 404, which contains a filtered and conditioned signal for a received RF band that is downcoverted to a lower frequency, is provided as an input to a Digital Signal Processing (DSP) module 408. Details of the DSP module 408 are discussed below. Transmitter 406 accepts a baseband input 407 that is generated by the DSP module 408, upconverts this baseband signal to the RF frequency required for transmission and sends the RF signal to antenna 402 for transmission. DSP module 408 accepts audio data 409 to and from audio processing circuits 410. Audio processing circuits 410 provide output audio signal to a speaker 416 and accept voice signals from microphone 414. DSP module 408 also communicates to and from the data processor/controller 412 data 411 that either was received or is to be transmitted. DSP module 408 provides demodulated data including both user data and service data. Service data in the exemplary embodiment includes RF channel and user timeslot assignments, incoming call notifications, and other housekeeping messages used by the wireless network. The data processor/controller 412 produces data to be transmitted from the wireless device, including service messages such as outgoing call requests, status messages, and other housekeeping messages. The data processor/controller 412 is further able to provide user data that is to be transmitted by the wireless device. The data processor/controller 412 accepts user controls from keypad 418, which is mounted on the enclosure of the wireless device and allows a user to enter commands and control the operation of the wireless device.

The receiver 404 and transmitter 406 of this exemplary embodiment are configured to simultaneously receive and transmit all of the RF channels within the plurality of RF channels used by this wireless device. In the example of the time to time/frequency division multiplexing diagram 300, receiver 404 and transmitter 406 have a receive and transmit bandwidth, respectively, of BW2 386. This results in the four RF channels of that example being simultaneously received and delivered to DSP module 408, and in DSP module 408 simultaneously generating the four RF channels for transmission. The programming of DSP module 408 is configured to process these four signals. The DSP module 408 of the exemplary embodiment is further able to be configured to receive a single TDM RF channel 302. Further, DSP module 408 is able to simultaneously receive and process a subset of RF channels within the plurality of RF channels 388.

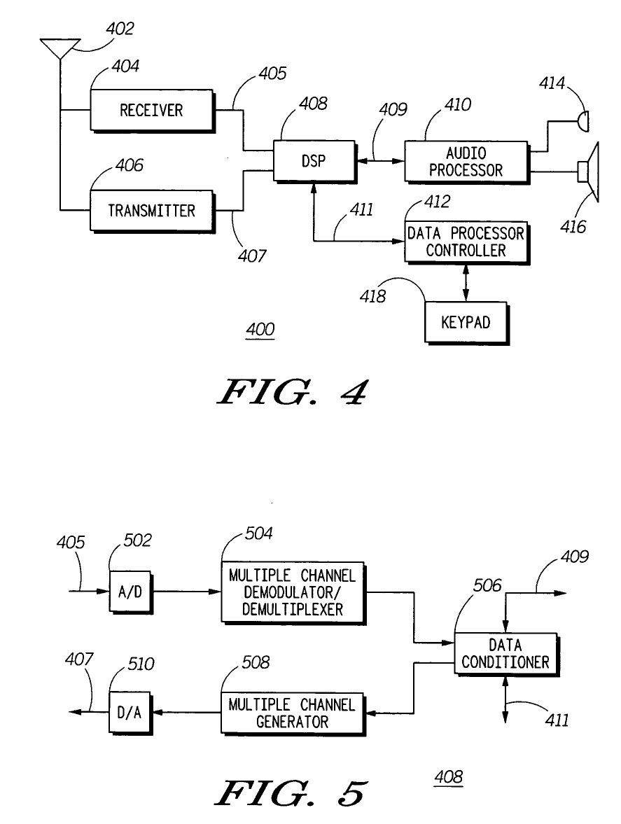

FIG. 5 illustrates a processing block diagram for DSP module 408. DSP module 408 is a multiple component module that in various embodiments of the present invention is able to include programmable processors, dedicated logic hardware, digitizers, and other circuits used to realized the processing described herein and as required by the operation of the wireless device. Received baseband signal 405 is provided to Analog to Digital (A/D) converter 502. The digital output of A/D converter 502 is provided to a multiple-channel demodulator/demultiplexer 504. The multiple channel demodulator/demultiplexer 504 applies digital signal processing to simultaneously demodulate the multiple carriers contained in the received plurality of RF channels. Such digital signal processing is familiar to ordinary practitioners in the relevant arts. The multiple channel demodulator/demultiplexer 504 provides demodulated data to a data conditioning processor 506, which processes the received data as required for use by other circuits. The data conditioning circuits 506 provides received data to a voice data interface 409 and a data interface 411, described below. The data conditioning circuits 506 further accept voice and data inputs from the voice data interface 409 and the data interface 411, conditions that data and provides that data to the multiple channel signal generator 508. The multi-channel signal generator 508 generates the multiple RF channels of the plurality of RF signals for transmission by the wireless device. A digitally encoded base band representation of these four carrier sis provided to a digital to analog (D/A) converter 510 for base band output to the transmitter 406.

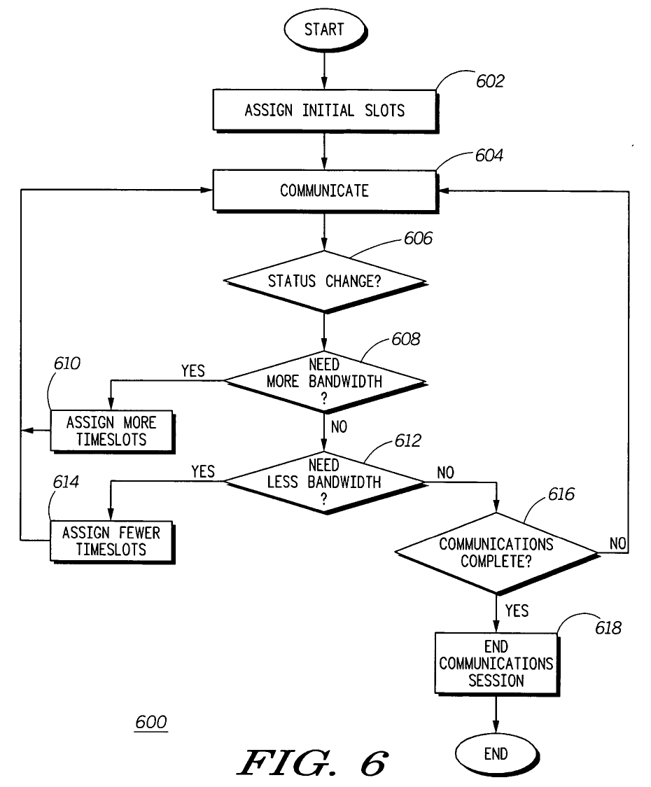

FIG. 6 illustrates a slot assignment processing flow diagram 600 as is performed by an exemplary embodiment of the present invention. The slot assignment processing in the exemplary embodiment is performed by controller 108 when establishing, maintaining and ending communications sessions either between wireless devices or between a wireless device and a landline connection, such as to the POTS 110 or Internet 112. The slot assignment processing begins by assigning, at step 602, an initial set of transmission and reception slots for the communications session. These slots are assigned in data transmissions by the base station 102 during service timeslots 210 or multiple channel service timeslots 312. A wireless device in the exemplary embodiment is able to be assigned a different number of uplink and downlink transmission slots according to the current data rate requirements for each transmission direction. The exemplary embodiment further attempts to assign multiple transmission user timeslots for an uplink or downlink that occur simultaneously in each of the plurality of RF channels so as to allow minimal RF signal reception processing.

After the initial set of timeslots is assigned to the wireless device, the communications session continues, at step 604. During the communications session, a status change is able to occur. Status changes include events that cause a change in either or both of the current transmit bandwidth or the current receive bandwidth. Such events can be caused by one end of the communications session desiring to transmit a block of data or to change a mode such as to start broadcasting video. The processing determines, at step 606, if such an event has occurred. If no event has occurred, the communications session continues, at step 604. If such an event has occurred, the processing continues by determining, at step 608, if an increase in bandwidth is required. If it is determined that an increase in bandwidth is required, the processing adjusts the number of time slots assigned to the wireless device and assigns, at step 610, addition timeslots for the affected link or links, i.e., either the uplink, downlink, or both. This increase in slot assignments is made by slot assignment transmissions in the multiple channel service timeslot 312 that specify an added number of time slots.

If it was determined that the event did not indicate that more bandwidth was required, the processing continues by determining, at step 612, if less bandwidth is required. If less bandwidth is required, the processing deallocates at least one timeslot for this wireless device and reduces, at step 614, the number of slots assigned to the affected link for that wireless device. The new slot assignments are assigned in the multiple channel service timeslot 312 specify this new, reduced number.

If the processing determines that less bandwidth was not required, the processing then determines, at step 616, if the communications session is complete, as would be indicated, for example, by the users of the wireless device. If the communications session is not complete, the processing returns to continuing the communication session, at step 604. If the communications session is complete, the processing ends, at step 618, the communications session by de-assigning all slots for that wireless device used by that communications session.

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The terms “between” and “among” are not to be interpreted as limiting, the use of “between” alone is not to be interpreted as a term of limitation that restricts an action to only two objects, and the use of “among” alone is not to be interpreted as a term of limitation that excludes an action from operating upon only two objects.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

1. A method for receiving digital data, the method comprising:
receiving a plurality of RF carriers, at least two carriers of the plurality of carriers divided into a periodic series of timeslots for each carrier, where each timeslot in the periodic series of timeslots is able to carry independent data content, the at least two carriers each modulated with different portions of a single data stream during at least one timeslot of each carrier within the periodic series of timeslots;
demodulating the at least two carriers to detect the different portions of the single data stream; and
assembling the different portions of the single data stream to reconstruct the single data stream.

2. The method according to claim 1, further comprising selectably receiving the single data stream on a dedicated carrier, the dedicated carrier divided into a periodic plurality of dedicated timeslots, the single data stream being periodically modulated during at least one of the periodic plurality of dedicated timeslots, the dedicated timeslots being longer than the at least one timeslot.

3. The method according to claim 1, wherein the at least one timeslot comprises at least two timeslots that are divided among at least two carriers, wherein the at least two timeslots occur simultaneously.

4. The method according to claim 3, the at least two carriers further comprise a service timeslot, and further comprising deactivating the receiver during at least a period of time outside of the at least one timeslot and the service timeslot.

5. The method according to claim 1, further comprising adjusting a number of timeslots within the at least one timeslot by one of adding at least one timeslot and de-allocating at least one timeslot.

6. The method according to claim 5, wherein the adjusting is performed in response to an event that changes a current data bandwidth requirement.

7. A method for transmitting digital data, the method comprising:
accepting a single data stream;
dividing the single data stream into different portions; and
modulating a plurality of RF carriers, at least two carriers of the plurality of carriers divided into a periodic series of timeslots for each carrier, where each timeslot in the periodic series of timeslots is able to carry independent data content, the at least two carriers each modulated with the different portions during at least one timeslot of each carrier within the periodic series of timeslots.

8. A wireless device, comprising:
a wireless receiver that receives a plurality of RF carriers, at least two carriers of the plurality of carriers divided into a periodic series of timeslots for each carrier, where each timeslot in the periodic series of timeslots is able to carry independent data content, the at least two carriers each modulated with different portions of a single data stream during at least one timeslot of each carrier within the periodic series of timeslots;
a demodulator, communicatively coupled with the wireless receiver, for demodulating the at least two carriers to detect the different portions of the single data stream; and
a demultiplexer, communicatively coupled with the demodulator, for assembling the different portions of the single data stream to reconstruct the single data stream.

9. The wireless device according to claim 8, therein the wireless receiver further selectably receives the single data stream on a dedicated carrier, the dedicated carrier divided into a periodic plurality of dedicated timeslots, the single data stream being periodically modulated during at least one of the periodic plurality of dedicated timeslots, the dedicated timeslots being longer than the at least one timeslot.

10. The wireless device according to claim 8, wherein the at least one timeslot of each carrier within the periodic series of timeslots occur simultaneously.

11. The wireless device according to claim 10, wherein the at least two carriers further comprising a service timeslot, and at least one of the wireless receiver, the demodulator, and the demultiplexer, deactivate during at least a period of time outside of the at least one timeslot and the service timeslot.

12. The wireless device according to claim 8, wherein at least one of the wireless receiver, the demodulator, and the demultiplexer, further adjusts a number of timeslots within the at least one timeslot by at least one of adding at least one timeslot and de-allocating at least one timeslot.

13. The wireless device according to claim 12, wherein at least one of the wireless receiver, the demodulator, and the demultiplexer, adjusts the number of timeslots in response to an event that changes a current data bandwidth requirement.

14. A computer program product comprising computer programming instructions for receiving digital data, the computer programming instructions comprising instructions for:
wirelessly receiving a plurality of RF carriers, at least two carriers of the plurality of carriers divided into a periodic series of timeslots for each carrier, where each timeslot in the periodic series of timeslots is able to carry independent data content, the at least two carriers each modulated with different portions of a single data stream during at least one timeslot of each carrier within the periodic series of timeslots;
demodulating the at least two carriers to detect the different portions of the single data stream; and
assembling the different portions of the single data stream to reconstruct the single data stream.

15. The computer program product according to claim 14, further comprising instructions for selectably receiving the single data stream on a dedicated carrier, the dedicated carrier divided into a periodic plurality of dedicated timeslots, the single data stream being periodically modulated during at least one of the periodic plurality of dedicated timeslots, the dedicated timeslots being longer than the at least one timeslot.

16. The computer program product according to claim 14, wherein the at least one timeslot comprises at least two timeslots that are divided among at least two carriers, wherein the at least two timeslots occur simultaneously.

17. The computer program product according to claim 16, wherein the at least two carriers further comprising a service timeslot, and the computer program product further comprising instructions for deactivating the receiver during at least a period of time outside of the at least one timeslot and the service timeslot.

18. The computer program product according to claim 14, further comprising instructions for adjusting a number of timeslots within the at least one timeslot by one of adding at least one timeslot and de-allocating at least one timeslot.

19. The computer program product according to claim 18, wherein the instructions for adjusting are performed in response to an event that changes a current data bandwidth requirement.
